(19) United States
(12) Patent Application Publication
(10) Pub. No.: US 2014/0164706 A1
(43) Pub. Date: Jun. 12, 2014

(54) MULTI-CORE PROCESSOR HAVING HIERARCHICAL CAHCE ARCHITECTURE

(71) Applicant: Electronics & Telecommunications Research Institute, Daejeon (KR)

(72) Inventor: Jae Jin LEE, Daejeon (KR)

(73) Assignee: Electronics & Telecommunications Research Institute, Daejeon (KR)

(21) Appl. No.: 14/103,771

(22) Filed: Dec. 11, 2013

(30) Foreign Application Priority Data
Dec. 11, 2012 (KR) 10-2012-0143647

(51) Int. Cl. G06F 12/08

(52) U.S. Cl. CPC G06F 12/0811
USPC 711/122

(57) ABSTRACT

Disclosed is a multi-core processor having hierarchical cache architecture. A multi-core processor may comprise a plurality of cores, a plurality of first caches independently connected to each of the plurality of cores, at least one second cache respectively connected to at least one of the plurality of first caches, a plurality of third caches respectively connected to at least one of the plurality of cores, and at least one fourth cache respectively connected to a least one of the plurality of third caches. Therefore, overhead in communications between cores may be reduced, and processing speed of application may be increased by supporting data-level parallelization.

### CLAIM FOR PRIORITY

This application claims priorities to Korean Patent Application No. 10-2012-0143647 filed on Dec. 11, 2012 in the Korean Intellectual Property Office (KIPO), the entire contents of which are hereby incorporated by references.

### BACKGROUND

1. Technical Field

Example embodiments of the present invention relate to a technology of multi-core processor and more specifically to a multi-core processor having hierarchical cache architecture.

2. Related Art

In response to user's desire for high-performance and multi-function, processors embedded in mobile terminal apparatuses such as smartphones and pad-type terminals are advancing from single core architecture to multi-core architecture having more than two cores. In consideration of trend in advances of processor technologies and miniaturization of processor, it is expected that processor architecture should advance to multi-core architecture having more than quad cores. Also, next-generation mobile terminal may be expected to use multi-core processor integrated with several tens to several hundreds of cores, and to make services such as biometrics service, augmented reality and the like possible.

Meanwhile, in order to enhance performances of processors, a method of increasing operating clock frequency has mainly been used. However, as clock frequency of a processor increases, power consumption and generated heat increase too. Therefore, there is a limit in enhancing processor performance by increasing clock frequency.

In order to overcome the above problem, multi-core architecture has been proposed and used, in which a single processor comprises a plurality of cores. In the multi-core processor, each core may operate at lower clock frequency than that of a single core processor. Therefore, power consumed by single core may be distributed to a plurality of cores, and so characteristic of high processing efficiency may be obtained.

Since using the multi-core architecture is similar to using a plurality of central processing units (CPU), a specific application may be executed in multi-core processor with higher performance as compared with case of single core processor, if the specific application supports multi-core processor. Also, when a multi-core processor is applied to next generation mobile terminal having functions of multimedia processing as basic functions, the multi-core processor may provide higher performance for application such as encoding/decoding video, game requiring high processing power, augmented reality and the like as compared with a single core processor.

The most important factor in designing multi-core processor is efficient cache architecture which supports functional parallelization and reduces overhead occurring in inter-core communications.

As a method for increasing performance in multi-core processor environment, a method of increasing performance and reducing communication overhead by using high-performance and high-capacity data cache and making large data shared by cores has been proposed. However, even though the above method is useful for the case that a plurality of cores share the same data such as video decoding application, the above method is not so useful for the case that each of the plurality of cores uses data different from those of each other.

Also, as a method of performing parallel processing efficiently in multi-core processor environment, a method of adjusting the number of cores assigned to information consumption processes or information allocation unit, and limiting access of the information consumption processes to process queues appropriately, based on status of common queue (or, shared memory) storing information shared by information production processes producing information and the information consumption processes consuming produced information has been proposed. However, the above method requires additional function module to perform monitoring on the shared memory (or, the common queue), and controlling accesses to the shared memory of each core, and there may be performance degradation caused by limiting access to the shared memory.

### SUMMARY

Accordingly, example embodiments of the present invention are provided to substantially obviate one or more problems due to limitations and disadvantages of the related art.

Example embodiments of the present invention provide a multi-core processor having hierarchical cache architecture which can reduce inter-core communication overhead and enhance performance in processing application.

In some example embodiments, a multi-core processor may comprise a plurality of cores, a plurality of first caches independently connected to each of the plurality of cores, at least one second cache respectively connected to at least one of the plurality of first caches, a plurality of third caches respectively connected to at least one of the plurality of cores, and at least one fourth cache respectively connected to a least one of the plurality of third caches.

Here, instructions and data for processing application executed by the plurality of cores may be stored in the first cache and the second cache, data shared by the plurality of cores may be stored in the third cache and the fourth cache.

Here, each of the plurality of third caches may be connected to at least two cores sharing data being processed.

Here, each of the plurality of third caches may be connected to two cores adjacent to each other.

Here, the plurality of cores may perform communications between cores by using preferentially the third cache among the plurality of third caches and the at least one fourth cache.

Here, the at least one second cache and the at least one fourth cache may be respectively connected to different memory through respective bus.

Here, the at least one fourth cache may be respectively connected to different number of the third caches.

Here, each of the at least one second cache may be connected to at least one of the first caches respectively connected to clustered core group among the plurality of cores.

Here, each of the at least one fourth cache may be connected to at least one of the third caches respectively connected to clustered core group among the plurality of cores.

### BRIEF DESCRIPTION OF DRAWINGS

Example embodiments of the present invention will become more apparent by describing in detail example embodiments of the present invention with reference to the accompanying drawings, in which:

FIG. 1 is a conceptual diagram to explain a method of process parallelization by data division in multi-core processor environment;

FIG. 2 is a flow chart to show a procedure of decoding video performed in multi-core processor environment;

FIG. 3 is a block diagram to show a structure of multi-core processor having hierarchical cache architecture according to an example embodiment of the present invention;

FIG. 4 is a conceptual diagram to explain data dependency of application executed in multi-core processor environment; and

FIG. 5 is a conceptual diagram to explain a method of data-level parallelization of a multi-core processor having hierarchical cache architecture according to an example of the present invention.

### DESCRIPTION OF EXAMPLE EMBODIMENTS

Example embodiments of the present invention are disclosed herein. However, specific structural and functional details disclosed herein are merely representative for purposes of describing example embodiments of the present invention, however, example embodiments of the present invention may be embodied in many alternate forms and should not be construed as limited to example embodiments of the present invention set forth herein.

Accordingly, while the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention Like numbers refer to like elements throughout the description of the figures.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

A multi-core processor having hierarchical cache architecture according to an example embodiment of the present invention may perform data-level parallelization on applications by dividing caches shared by each of cores hierarchically and making them used by each of cores, and minimize inter-core communication overhead.

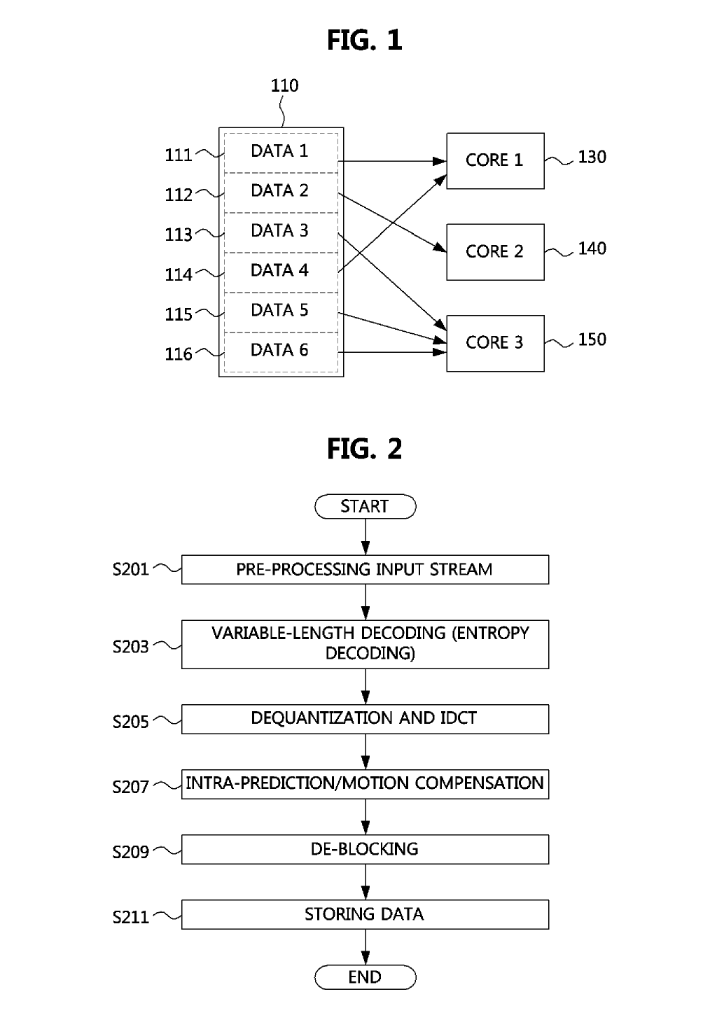

FIG. 1 is a conceptual diagram to explain a method of process parallelization by data division in multi-core processor environment.

Referring to FIG. 1, in a method of process parallelization by data division, whole data to be processed may be divided into a plurality of data 111 to 116, and each divided data 111 to 116 may be performed in different core 130, 140, and 150. Therefore, the method can perform the parallelization efficiently in the case that dependency between divided data 111 to 116 is low.

That is, when the multi-core processor is supposed to comprise three cores 130, 140, and 150 as shown in FIG. 1, whole data 110 to be processed may be divided to first data 111 to sixth data 116. Then, the first data 111 and the fourth data 114 may be processed in a first core 130, and the second data 112 may be processed in a second core 140, and the third, the fifth, and the sixth data 113, 115, and 116 may be processed in a third core 150. Thereby, whole performance may be enhanced since each of cores 130, 140 and 150 can process the same function with different data.

FIG. 2 is a flow chart to show a procedure of decoding video performed in multi-core processor environment, and may show a procedure of decoding video as an example in that a plurality of cores process data by dividing the data in multi-core processor environment.

In a procedure of decoding video, data to be processed by a plurality of cores may be classified into units of frames, units of slices, units of macro block (MB), and units of blocks.

Referring to FIG. 2, a procedure of decoding video may include a step S201 of pre-processing input stream, a step S203 of variable length decoding, a step S205 of dequantization and inverse discrete cosine transform, a step S207 of intra-prediction and motion compensation, a step S209 of de-blocking, and a step S211 of storing data. In each step of the procedure, a plurality of cores may perform the same functions on the same data.

In the step S201 of pre-processing input stream, data generated in an encoder may be stored in an input buffer by unit of network abstract layer (NAL), type information of NAL (nal_unit_type) included in a header of NAL unit may be read out, and a decoding method of the rest of NAL data may be determined according to the NAL type.

In the step S203 of variable length decoding, an entropy decoding on data inputted in the input buffer may be performed, and the entropy decoded data may be re-ordered according a scan sequence. The data which is reordered in this step may be data quantized by the encoder.

In the step S205 of dequantization and inverse discrete cosine transform, dequantization on the reordered data may be performed, and then inverse discrete consine transform (IDCT) may be performed.

In the step S207 of intra-prediction and motion compensation, intra-prediction or motion compensation may be performed on the data on which the IDCT is performed, for example, macro-block of block data), and prediction data may be generated. Here, the generated prediction data is summed to the IDCT transformed data, and may become a decoded picture (or, restored picture) after block distortion filtering in the step S209 of de-blocking. The decoded picture (or restored picture) may be stored to be used as reference picture for later decoding process at S211.

In the procedure of decoding video as shown in FIG. 2, each core may perform the same function on different data (for example, different macro block or block) so that processing performance may be increased. However, when a plurality of cores use a single common cache, processing performance may be degraded due to a bottle neck phenomenon occurring while the plurality of cores access the common cache. Also, overhead of communication between cores may increase as the number of cores increases, and whole performance may be degraded.

Therefore, in order to increase processing performance in multi-core processor environment, a support of data-level parallelization and efficient communication architecture of each core for it may be needed. A multi-core processor according to an example embodiment of the present invention may configure caches for executing application separately, reduce overhead of communications between adjacent cores by configuring the caches hierarchically, and enhance whole processing performance by supporting data-level parallelization during execution of application.

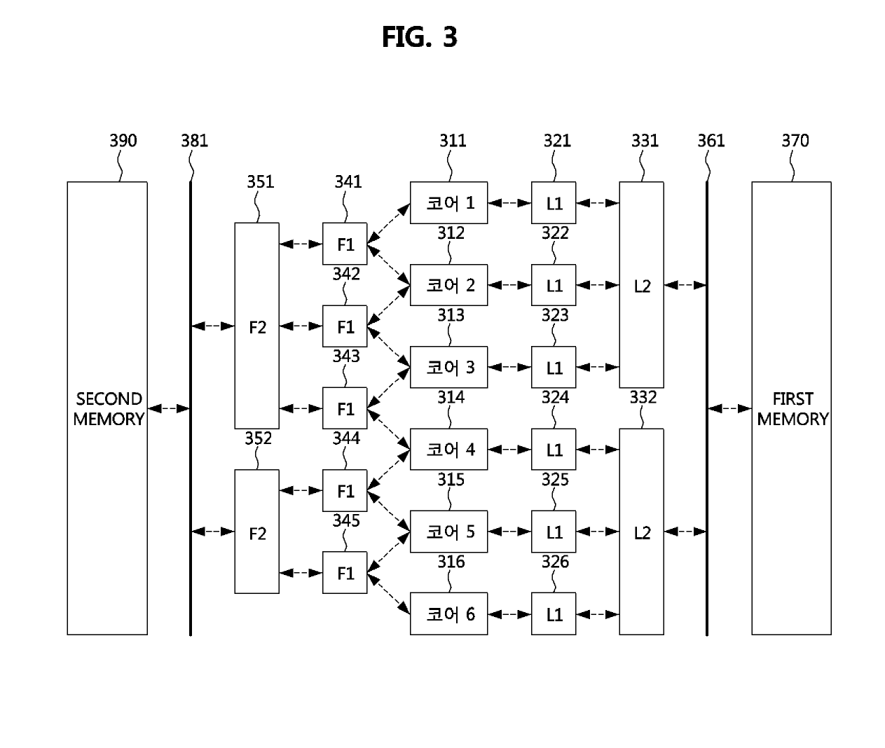

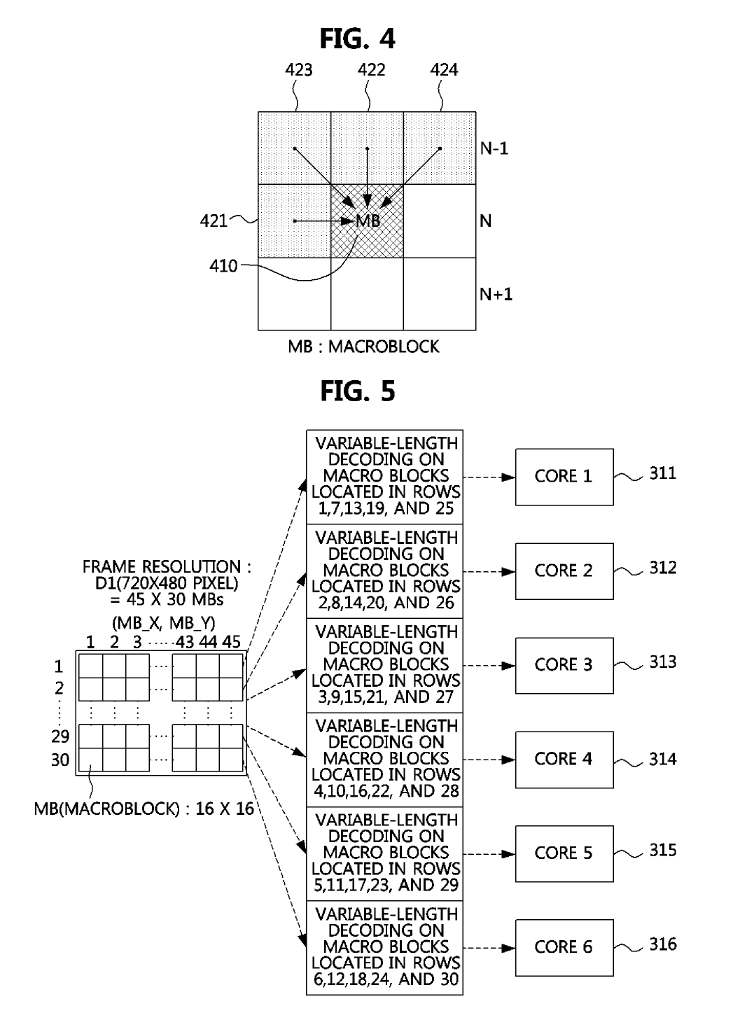

FIG. 3 is a block diagram to show a structure of multi-core processor having hierarchical cache architecture according to an example embodiment of the present invention, may show hierarchical cache architecture of multi-core processing performing video decoding as one of multimedia applications for example. FIG. 4 is a conceptual diagram to explain data dependency of application executed in multi-core processor environment.

Referring to FIG. 3 and FIG. 4, a multi-core processor, having hierarchical cache architecture according to an example embodiment of the present invention, may include a plurality of cores 311˜316; a plurality of L1 caches 321˜326; L2 caches 331, 332; F1 caches 341˜345; and F2 caches 351, 352. The L1, L2, F1 and F2 caches may be constructed in hierarchical architecture.

Specifically, the L1 cache 321˜236 and the L2 caches 331, 332 are cache memories storing codes and data for execution of application, and each of the L1 caches 321˜326 may be independently assigned to each of cores 311˜316, and the L2 caches may be configured to be connected to the predetermined number of L1 caches. Or, each of L2 caches may be connected to L1 caches connected to clustered cores so that each of L2 caches can be connected to clustered cores.

For example, a first core 311, a second core 312, and a third core 313 are supposed to be clustered, and a fourth core 314, a fifth core 315, and a sixth core 316 are supposed to be clustered. In this case, the L2 cache 311 may be the L1 caches 321 to 323 which are respectively connected to clustered cores 311 to 313, and the L2 cache 332 may be connected to the L1 caches 324 to 326 which are respectively connected to clustered cores 314 to 316.

Each of L1 caches 321˜326 is a storage for processing frequently repetitive computations by each of cores 311˜316, and may be used for storing instructions or data to be processed immediately by each of cores 311˜316. Also, the L2 caches 331, 332 may be used as storage storing data in advance to be processed after while each of cores 311˜316 processes data by using corresponding L1 cache 321˜326.

The size of each L1 cache 321˜326 may be configured to be identical, or may be configured to be different. Also, the number of L1 caches connected to each of L2 caches 331, 332 may be configured to be identical, or may be configured to be different. For example, each L2 cache may be connected to 2˜10 L1 caches.

As shown in FIG. 3, the L2 cache 331 may be connected to three L1 caches 321, 322, and 323, the L2 cache 332 may be connected to three L1 caches 324, 325, and 326. Or, the L2 cache 331 and the L2 cache 332 may be configured to be connected to different number of L1 caches. Also, the size of each of L2 caches 331, 332 may be larger than the size of L1 caches 321˜326. The size of each of L2 caches 331, 332 may be identical, or may be different.

Also, each of L2 caches 331, 332 may be connected to a first memory 370 through a first bus 361. Here, the first memory 370 may be used for storing instructions and data to execute application.

Meanwhile, data dependency should be considered in the case that a plurality of cores perform processing in parallel in multi-core processor environment.

For example, in the case that a multi-core processor performs video decoding, as shown in FIG. 4, in order to perform intra-prediction on a current macro block, left 421, up 422, upper left 423, upper right 424 macro blocks should be referred, and so processing the macro blocks 421˜424 should be processed in advance.

Also, in the case that video decoding is performed through data-level parallelization in multi-core processor environment, basically data sharing is performed, since macro blocks located in the same row are processed by the same core. However, since adjacent rows may be processed by different cores, a method of efficiently sharing data by adjacent two cores may be required.

For example, when macro block located in a (N−1)th row are processed by the first core and macro blocks in a Nth row are processed by the second core, in order for the second core to perform decoding procedure on the current macro block 410, decoding result of the macro block in the (N−1)th row processed by the first core is required to be referred by the second core, and so data sharing between the first and the second cores becomes necessary.

A multi-core processor having hierarchical cache architecture according to an example embodiment of the present invention may include F1 caches 341˜345 and F2 caches 351, 352, which can be shared by cores and have hierarchical architecture, in order to satisfy the above requirement.

Specifically, in multi-core processor supporting data-level parallelization, the F1 caches 341˜345 are caches used for a plurality of cores to share data processed by each core. Therefore, adjacent two cores may be connected to a F1 cache, or a plurality of cores sharing data to be processed which are not adjacent may be connected to a F1 cache. Here, each of F1 caches 341˜345 may be configured to have the same size, or may be configure to have different sizes according to core correspondingly connected to each F1 cache.

By configuring each of F2 caches 351, 352 to be connected to several F1 caches (for example, 2˜10 F1 caches), each of F2 caches may be used for supporting efficient data sharing between clustered cores even though the clustered cores are not adjacent. For example, when the first core 311, the second core 312, and the third core 313 are clustered, and the fourth core 314, the fifth core 315, and the sixth core 316 are clustered, the F2 cache 351 may be connected to the F1 caches 341˜343 connected to the clustered cores 311˜313, and the F2 cache 352 may be connected to the F1 caches 344, 345 connected to the clustered cores 314˜316.

Each of F2 caches 351, 352 may be configured to have the same size, or may be configured to have different sizes. Also, the number of F1 caches connected to each of the F2 cache 351, 352 may be configured to be the same or not.

When a multi-core processor performs video encoding or decoding, the F1 caches 341˜345 and the F2 caches 351, 352 may be used for sharing data, for example macro block data, to be encoded or decoded between adjacent cores.

Also, each of F2 caches 351, 352 may be connected to a second memory 390 through a second bus 381. Here, the second memory 390 may be used for storing source data used during execution of application. For example, in the case that a multi-core processor performs video encoding or decoding, the second memory may be used for storing frame data required in procedures of video encoding or decoding.

As shown in FIG. 3, in a multi-core processor having hierarchical cache architecture according to an example embodiment of the present invention, caches are configured as L1 caches 321˜326, L2 caches 331 and 332, F1 caches 341˜345, and F2 caches 351 and 352 separately according to their uses and whether or not to share data. The L1, L2, F1, and F2 caches are constituted hierarchically, and each core may perform communications by using low level caches first. Then, each core may perform communications by using higher level caches when necessary, and so overhead of communications may be reduced so as to enhance performance of processing application.

Although a hierarchical architecture of a multi-core processor including six cores 311˜316, six L1 caches 321˜326, two L2 caches 331, 332, five F1 caches 341˜345, and two F2 cache 351, 352 is shown in FIG. 3 as an example, technical thought of the present invention is not limited to the structure of multi-core processor depicted in FIG. 3. The technical thought of the present invention may include various types and configurations of multi-core processors comprising caches divided according to purpose of uses and whether or not to support data sharing between cores, and configured hierarchically.

FIG. 5 is a conceptual diagram to explain a method of data-level parallelization of a multi-core processor having hierarchical cache architecture according to an example of the present invention.

In FIG. 5, a procedure that a multi-core processor having six cores performs a decoding of video frame with a resolution of 720×480 is shown as an example.

Hereinafter, referring to FIG. 3 and FIG. 5, data-level parallelization of a multi-core processor will be explained.

First, video frames with a resolution 720×480 are provided sequentially, and a video frame may be divided into 45×30 macro blocks each of which has a size of 16×16, and each of cores 311˜316 may perform decoding on macro blocks located in specific rows assigned to itself.

For example, in the case of a multi-core processor having six cores 311˜316, a first core 311 may perform variable-length decoding on macro blocks located in rows 1, 7, 13, 19, and 25 among total 45 rows so as to obtain quantized data and parameters for decoding.

Also, a second core 312 may perform variable-length decoding on macro blocks located in rows 2, 8, 14, 20, and 26 among the total 45 rows.

That is, the first core 311 and the second core 312 may perform variable-length decoding on rows adjacent to each other (for example, rows 1 and 2, rows 7 and 8). Here, the video frame with a resolution 720×480 may be stored in a second memory 390, and macro blocks located in at least two rows adjacent to each other among 45×30 macro blocks may be stored in a F2 cache 351. Also, among a plurality of macro blocks stored in the F2 cache 351, data of current macro block being decoded by each of cores 311 and 312 and/or decoded data of at least one macro blocks may be stored in F1 caches 341 and 342 or the F2 cache 351, so as to be referred by other cores performing decoding on adjacent macro blocks.

Also, the third core 313 may perform variable-length decoding on macro blocks location in rows 3, 9, 15, 21, and 27, which are next to the rows in which the macro blocks processed by the second core 312 are located, among macro blocks of 45 rows, and obtain quantized data and parameters for decoding. Here, the third core 313 may perform the decoding by referring to decoded data stored in the F1 cache 342, and store decoded macro block data in the F1 cache 343 to be referred when the fourth core 314 decodes macro blocks assigned to the fourth core 314.

The fourth core 314 may perform variable-length decoding on macro blocks location in rows 4, 10, 16, 22, and 28, which are next to the rows in which the macro blocks processed by the third core 313 are located, among macro blocks of 45 rows, and obtain quantized data and parameters for decoding. Here, the fourth core 314 may perform the decoding by referring to decoded data stored in the F1 cache 343, and store decoded macro block data in the F1 cache 344 to be referred when the fifth core 315 decodes macro blocks assigned to the fifth core 315.

The fifth core 315 may perform variable-length decoding on macro blocks location in rows 5, 11, 17, 23, and 29, which are next to the rows in which the macro blocks processed by the fourth core 314 are located, among macro blocks of 45 rows, and obtain quantized data and parameters for decoding. Here, the fifth core 315 may perform the decoding by referring to decoded data stored in the F1 cache 344, and store decoded macro block data in the F1 cache 345 to be referred when the sixth core 316 decodes macro blocks assigned to the sixth core 316.

The sixth core 316 may perform variable-length decoding on macro blocks location in rows 6, 12, 18, 24, and 30, which are next to the rows in which the macro blocks processed by the fifth core 315 are located, among macro blocks of 45 rows, and obtain quantized data and parameters for decoding. Here, the sixth core 316 may perform the decoding by referring to decoded data stored in the F1 cache 345.

According to the multi-core processor having hierarchical cache architecture as explained above, L1 and L2 caches, in which each core stores codes and data for executing application, may be configured hierarchically, and F1 and F1 caches, which each core uses for sharing data during execution of application, may be configured hierarchically. Then, each core may use low-level caches first to perform communications, and may perform communications by using higher level caches hierarchically when necessary.

Thus, overhead in communication between cores may be reduced, and processing speeds of applications may be increased by supporting data-level parallelization.

Also, in various multi-core or application environments, performance may be further enhanced by using the hierarchical cache architecture according to an example of the present invention even when the number of cores increases a lot.

While the example embodiments of the present invention and their advantages have been described in detail, it should be understood that various changes, substitutions and alterations may be made herein without departing from the scope of the invention.

What is claimed is:

1. A multi-core processor comprising:
a plurality of cores
a plurality of first caches independently connected to each of the plurality of cores;
at least one second cache respectively connected to at least one of the plurality of first caches;
a plurality of third caches respectively connected to at least one of the plurality of cores; and
at least one fourth cache respectively connected to a least one of the plurality of third caches.

2. The multi-core processor of the claim 1, wherein instructions and data for processing application executed by the plurality of cores are stored in the first cache and the second cache, data shared by the plurality of cores are stored in the third cache and the fourth cache.

3. The multi-core processor of the claim 1, wherein each of the plurality of third caches is connected to at least two cores sharing data being processed.

4. The multi-core processor of the claim 1, wherein each of the plurality of third caches is connected to two cores adjacent to each other.

5. The multi-core processor of the claim 1, wherein the plurality of cores performs communications between cores by using preferentially the third cache among the plurality of third caches and the at least one fourth cache.

6. The multi-core processor of the claim 1, where the at least one second cache and the at least one fourth cache are respectively connected to different memory through respective bus.

7. The multi-core processor of the claim 1, wherein the at least one fourth cache is respectively connected to different number of the third caches.

8. The multi-core processor of the claim 1, wherein each of the at least one second cache is connected to at least one of the first caches respectively connected to clustered core group among the plurality of cores.

9. The multi-core processor of the claim 1, wherein each of the at least one fourth cache is connected to at least one of the third caches respectively connected to clustered core group among the plurality of cores.
